(19) United States
(12) Patent Application Publication
(10) Pub. No.: US 2023/0264620 A1
(43) Pub. Date: Aug. 24, 2023

(54) EJECTOR BLADE AND MOUNTING ASSEMBLY

(71) Applicant: K-Tec Earthmovers Inc., Rosenort (CA)

(72) Inventors: Greg Martinsen, Ashland, WI (US); Brendan Pucel, Ashland, WI (US); Jonathan Dueck, Lowe Farm (CA); Kenneth Rempel, Greybull, WY (US); Shaun Eidse, Rosenort (CA); Abram Wiens, St. Jean (CA)

(21) Appl. No.: 18/110,768

(22) Filed: Feb. 16, 2023

Related U.S. Application Data
(60) Provisional application No. 63/311,598, filed on Feb. 18, 2022.

(51) Int. Cl. B60P 1/00

(52) U.S. Cl. CPC B60P 1/006

(57) ABSTRACT

A rear ejector body comprising a receptacle and an ejector blade mounted to the receptacle via an ejector blade mounting assembly comprising a first side mount and second side mount each connected to the side portions of the ejector blade body, the first and second side mount each including a sled for receiving a respective side mounting rail to support the ejector blade and a central mount configured for insertion onto a floor mounting rail. In various embodiments the central mount is positioned on a bottom surface of the hydraulic housing where the central mount includes a rearward aperture and a forward aperture and defines a pathway between to receive the floor mounting rail, the floor mounting rail having a wider top portion than bottom portion such that the floor mounting rail, when received in the pathway of the central mount, resists upward movement of the ejector blade.

### RELATED APPLICATIONS

The present application claims the benefit of U.S. Provisional Pat. Application No. 63/311,598, filed Feb. 18, 2022, the disclosure of which is incorporated by reference herein in its entirety.

### FIELD OF THE DISCLOSURE

The present disclosure relates to ejector blades, and more specifically, to an ejector blade and mounting assembly for mounting to a receptacle.

### BACKGROUND

In earth moving operations, work machines are commonly used to move earth material, such as dirt, rock, clay, and the like. Work machines that are commonly used to perform this task include dump trucks and ejector trucks. Both types of trucks have a receptacle body to carry the material but differ in operation to dump or otherwise remove carried material from the receptacle body. For example, a dump truck typically operates by tilting one portion of its receptacle body and utilizing gravity to dump carried material out a rear end of the receptacle body. In an ejector truck, an ejector blade is moveably mounted within the receptacle body and is coupled to a hydraulic ram or cylinder or other mechanical means which extend and retract to move the blade through the body to push or eject material.

Ejector trucks are useful in many applications, including applications where a traditional tilting dump truck is undesirable or impractical. For instance, if there are power lines or a low bridge or other structure located above the worksite, the ejector truck can dump its load without contacting the overhead obstruction. Also, an ejector truck can better maintain stability while dumping and can spread material while moving, thereby reducing the spreading cost and reducing the truck cycle time making it more cost efficient. The ejector truck can also dump and spread the material more accurately than can a gravity-powered tilting dump truck, since the powered ejector blade gives the operator a great deal of control over the flow rate and distribution of the material.

Another advantage of ejector blade machines is that the ejector blade cleans all the sticky materials out of the receptacle body. In contrast, some of the material in the receptacle body of regular dump trucks can get stuck or frozen to the sides and floor of the receptacle body. In the industry this is known as “carry back” since the material that is stuck in the receptacle body is carried in the receptacle body even after the load has been dumped. Carry back builds up thereby making conventional dump trucks inefficient since they lose load capacity which adds to the cost of operations.

Effort has been made to improve the field of ejector devices. For example, see U.S. Pats.: 3,021,968; 3,953,170; 4,260,317; 4,632,628; 5,273,390; 6,079,933; 6,092,973; 6,102,644; 6,374,606; 6,561,747; 6,672,822; 7,878,751; 7,980,805; 8,333,543; and 9,453,323. Further, see U.S. Pat. Publications: 2004/0173088; 2006/0045702; 2008/0298941; 2014/0219755; and 2017/0190274. These patents and patent publications are hereby incorporated by reference in their entirety.

### SUMMARY

According to embodiments of the present disclosure, a rear ejector body for use with a work vehicle is disclosed. In various embodiments the ejector body includes a receptacle including a floor and a pair of opposing sidewalls that extend upwardly from the floor. In one or more embodiments the floor and sidewalls define a forward end of the receptacle and a rearward end of the receptacle. In various embodiments the ejector body includes side mounting rails attached to a top end of each of the pair of opposing sidewalls, the side mounting rails extending to the open rearward end along at least a portion of a length of the receptacle. In various embodiments the ejector body includes a floor mounting rail attached to a top surface of the floor, the floor mounting rail extending to the open rearward end along at least a portion of a length of the receptacle.

In one or more embodiments, the ejector body includes an ejector blade having a body extending between the pair of opposing sidewalls and including a lower portion adjacent to the floor and side portions adjacent to the opposing sidewalls. In various embodiments the ejector blade further includes a hydraulic housing extending rewardly from the ejector blade body for at least partially containing a hydraulic actuator, where the ejector blade is slidingly mounted to the receptacle via an ejector blade mounting assembly.

In various embodiments the ejector blade mounting assembly includes a first side mount and second side mount each connected to the side portions of the ejector blade body. In one or more embodiments the first and second side mount each include a sled for receiving a respective side mounting rail to support the ejector blade on the opposing sidewalls. In one or more embodiments the mounting assembly includes a central mount configured for insertion onto the floor mounting rail, the central mount positioned on a bottom surface of the hydraulic housing where the central mount includes a rearward aperture and a forward aperture and defines a pathway between to receive the floor mounting rail, the floor mounting rail having a wider top portion than bottom portion such that the floor mounting rail, when received in the pathway of the central mount, resists upward movement of the ejector blade. In various embodiments the hydraulic actuator includes a first end connected to a first hydraulic support structure attached to the forward end of the receptacle and a second end mounted to the hydraulic housing. In one or more embodiments the hydraulic actuator is configurable between a retracted position and an extended position for moving the ejector blade between the forward end and rearward end of the receptacle.

As a result, various embodiments of the disclosure provide advantages in the form of a three-point ejector guide system or mounting assembly for improved stability. Further, in various embodiments the mounting assembly includes no individually moving parts or rollers and instead utilize use metal on metal adjustable wear plates to provide a relatively low friction surface to slide the ejector blade. In such embodiments this allows control of the ejector, while also providing for adjustability and easy replacement if components are damaged. In addition, such embodiments result in minimal grease points to minimize daily maintenance and adjustment. Further, various embodiments of the disclosure provide advantages in the form of a modular design that allows embodiments to be easily assembled or disassembled, via bolts or other removable fasteners. For example, in various embodiments the receptacle is modular where the floor comprises a first piece and a second piece that are assembled together along a lengthwise seam that extends between the forward end and the open rearward end of the receptacle to form the floor. In such embodiments the ejector device can be more easily packed or shipped to an intended destination. For example, such embodiments being able to be more easily fit within a 40′ sea container.

The above summary is not intended to describe each illustrated embodiment or every implementation of the present disclosure.

### BRIEF DESCRIPTION OF THE SEVERAL VIEWS OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a rear perspective view of an ejector box, according to one or more embodiments of the disclosure.

FIG. 2 depicts a side view of an ejector box, according to one or more embodiments of the disclosure.

FIG. 3 depicts a top view of an ejector box, according to one or more embodiments of the disclosure.

FIG. 4 depicts a rear view of an ejector box, according to one or more embodiments of the disclosure.

FIG. 5 depicts a front view of an ejector box, according to one or more embodiments of the disclosure.

FIG. 6 depicts a rear perspective view of an ejector box with an ejector blade in an extended position, according to one or more embodiments of the disclosure.

FIG. 7 depicts a disassembled view of a receptacle of an ejector box having a first piece and second piece, according to one or more embodiments of the disclosure.

FIG. 8 depicts a forward perspective view of a receptacle in a stage of assembly, according to one or more embodiments of the disclosure.

FIG. 9 depicts a forward perspective view of a receptacle in a stage of assembly, according to one or more embodiments of the disclosure.

FIG. 10 depicts a rear perspective view of an ejector blade, according to one or more embodiments of the disclosure.

FIG. 11 depicts a rear view of an ejector blade, according to one or more embodiments of the disclosure.

FIG. 12 depicts a side view of an ejector blade, according to one or more embodiments of the disclosure.

FIG. 13 depicts a front view of an ejector blade, according to one or more embodiments of the disclosure.

FIG. 14 depicts a bottom perspective view of an ejector blade, according to one or more embodiments of the disclosure.

FIG. 15 depicts a rear perspective view of an ejector box, according to one or more embodiments of the disclosure.

FIG. 16 depicts a side view of an ejector box, according to one or more embodiments of the disclosure.

FIG. 17 depicts a top view of an ejector box, according to one or more embodiments of the disclosure.

FIG. 18 depicts a rear view of an ejector box, according to one or more embodiments of the disclosure.

FIG. 19 depicts a front view of an ejector box, according to one or more embodiments of the disclosure

FIG. 20 depicts a bottom perspective view of an ejector blade, according to one or more embodiments of the disclosure.

FIG. 21 depicts a partial front view of an ejector blade, according to one or more embodiments of the disclosure.

FIG. 22 depicts a partial rear view of an ejector blade, according to one or more embodiments of the disclosure.

While the embodiments of the disclosure are amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION

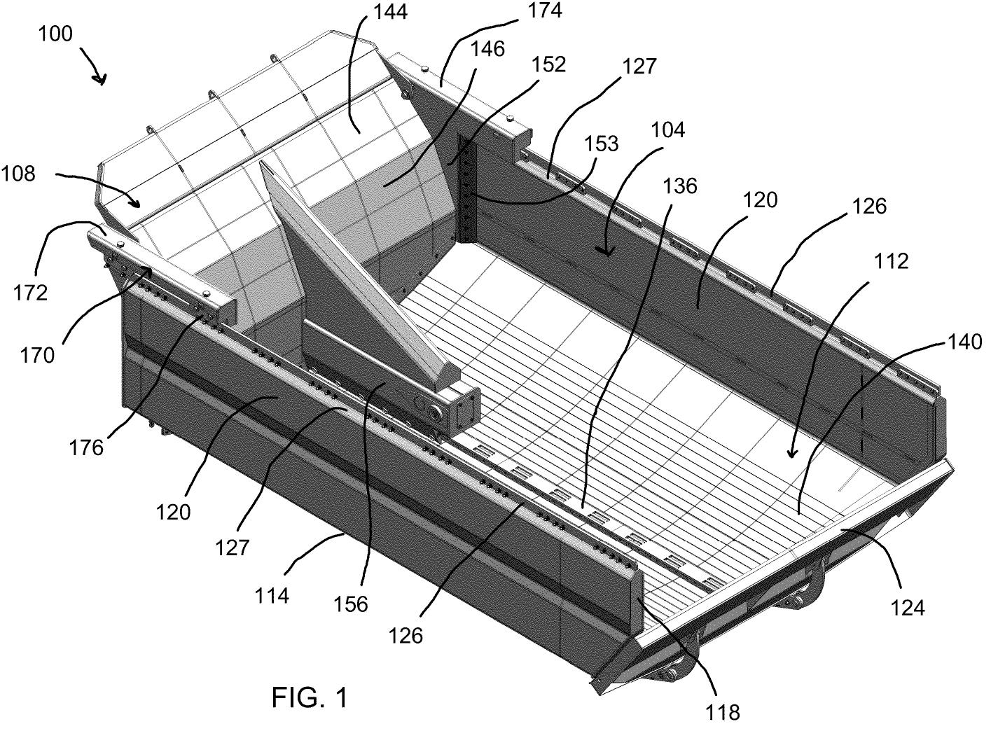

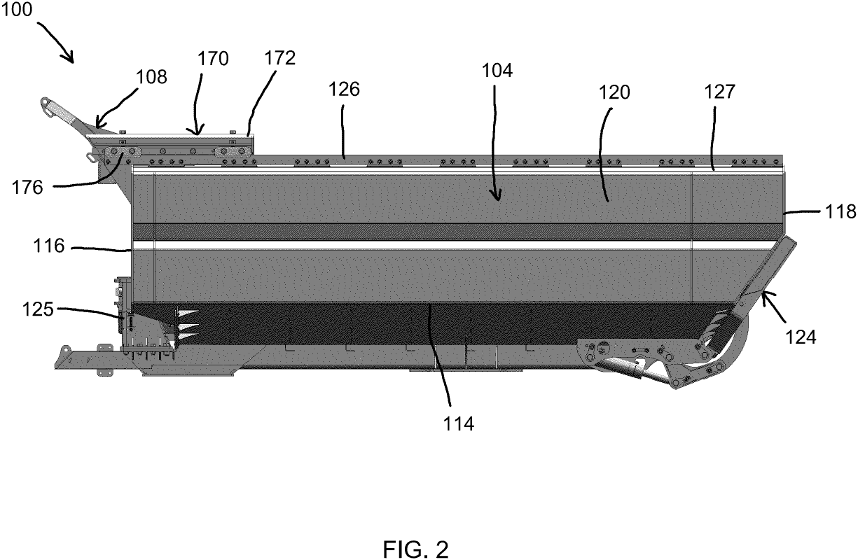

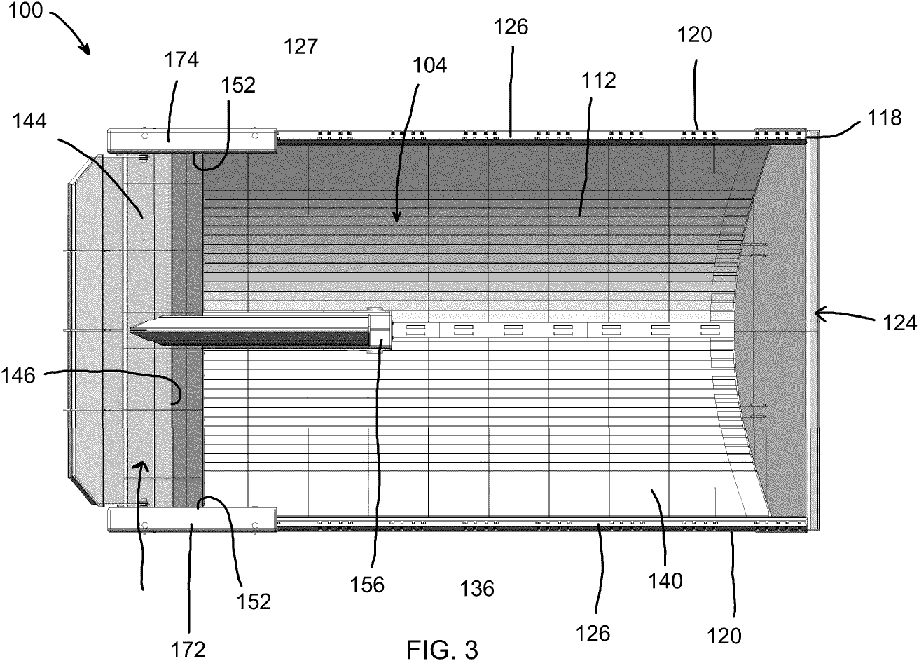

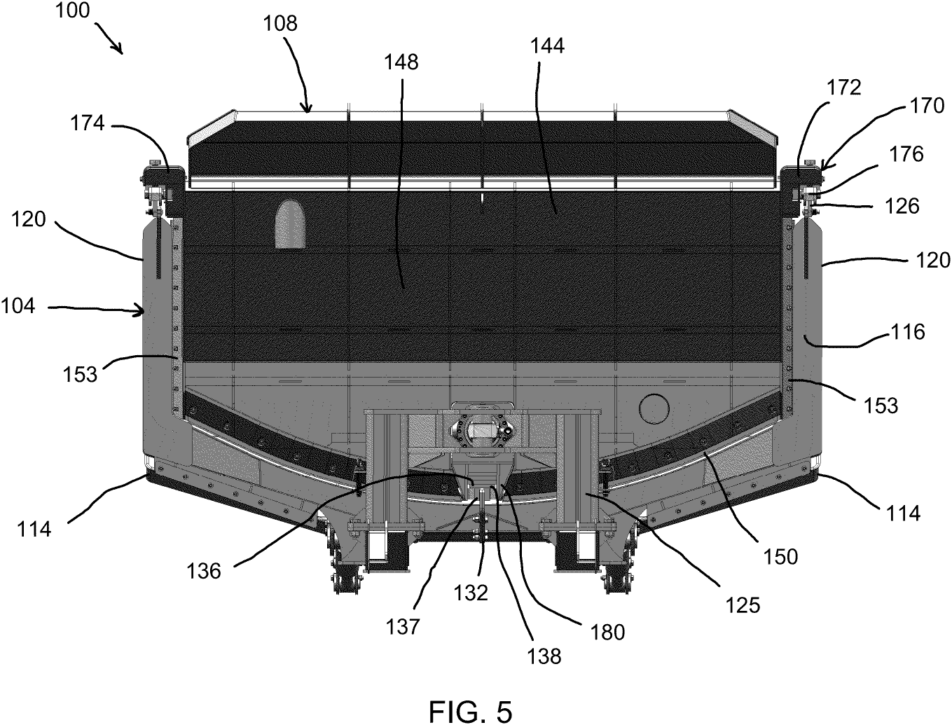

Referring to FIGS. 1-6, various views of an ejector box 100 is depicted according to one or more embodiments of the disclosure. According to various embodiments, the ejector box 100 is an earthmoving device used for earth moving operations to move material such as dirt, rock, clay, and various other materials and eject or dump its contents in a controlled manner. As such, in various embodiments the ejector box 100 includes a receptacle 104 that is configured to contain material, and an ejector blade 108 for dumping or ejecting the material out of the receptacle 104. Further, in various embodiments, the ejector box 100 is attachable to a working vehicle such as a truck, tractor, articulated truck, or other vehicle.

In one or more embodiments, the receptacle 104 includes a floor 112 having longitudinally extending sides 114, a forward end 116, and a rear end 118. In various embodiments, the receptacle 104 includes opposing sidewalls 120 that are attached, respectively, to the longitudinally extending sides 114 of the floor 112 and extend upwardly from the floor 112. In one or more embodiments the forward end 116 and rear end 118 of the receptacle 104 are defined as sides of the floor 112 that are positioned between the sidewalls 120. In various embodiments - and notwithstanding other ejector box 100 elements such as the tailgate 124, which is described further below - the rear end 118 of the receptacle 104 is open such that material can be ejected or pushed out of the receptacle 104 by the ejector blade 108 via the rear end 118. In contrast, in certain embodiments the forward end 116 can, in some embodiments, include a forward sidewall, or other structure positioned at the front of the ejector box 100.

In one or more embodiments, the ejector box 100 includes side mounting rails 126 that are attached to a top end 127 of each of the sidewalls 120 to form an upwardly extending track or rail on the sidewalls 120. Described further below, in various embodiments the side mounting rails 126 provide at least a portion of an ejector blade mounting means on the receptacle 104, where the side mounting rails 126 are received by an ejector blade mounting assembly to allow the ejector blade 108 to move between the forward end 116 and the rear end 118. As such, in one or more embodiments each of the side mounting rails 126 include one or more rail elements that together form a track extending along at least a portion of the sidewalls 120 to at least the rear end 118.

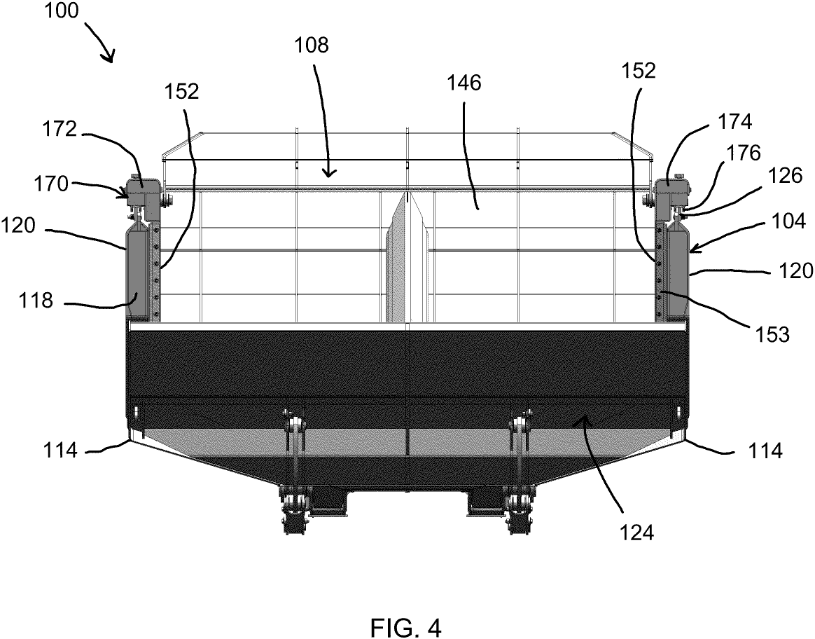

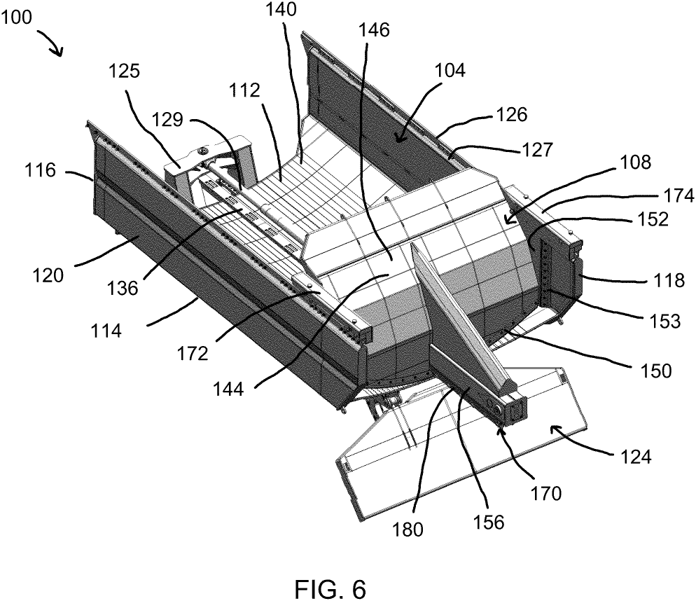

In one or more embodiments the receptacle 104 includes a tailgate 124 pivotally attached to the rear end 118 of the receptacle 104 and positioned between the pair of opposing sidewalls 120. In such embodiments the tailgate 124 is configured for movement between a closed position and an open position for selectively allowing material in the receptacle 124 to be ejected from the rear end 118 using the ejector blade 108. For example, depicted in FIG. 4, the tailgate 124 is in a closed position where the tailgate 124 forms a barrier to contain material in the receptacle 104. Depicted in FIG. 6, the tailgate 124 is pivoted into an open position, where the tailgate 124 allows material to be ejected from the rear end 118 via the ejector blade 108.

In various embodiments the receptacle 104 includes a hydraulic support structure 125 attached to the forward end 116 of the receptacle 104. Described further below, in one or more embodiments a hydraulic actuator 129 is attached to the hydraulic support structure 125 and the ejector blade 108, where the hydraulic actuator 129 is configurable between a retracted position and an extended position for moving the ejector blade 108 between the forward end 116 and rearward end 118 by using the hydraulic support structure 125 to apply a translational force on the ejector blade 108.

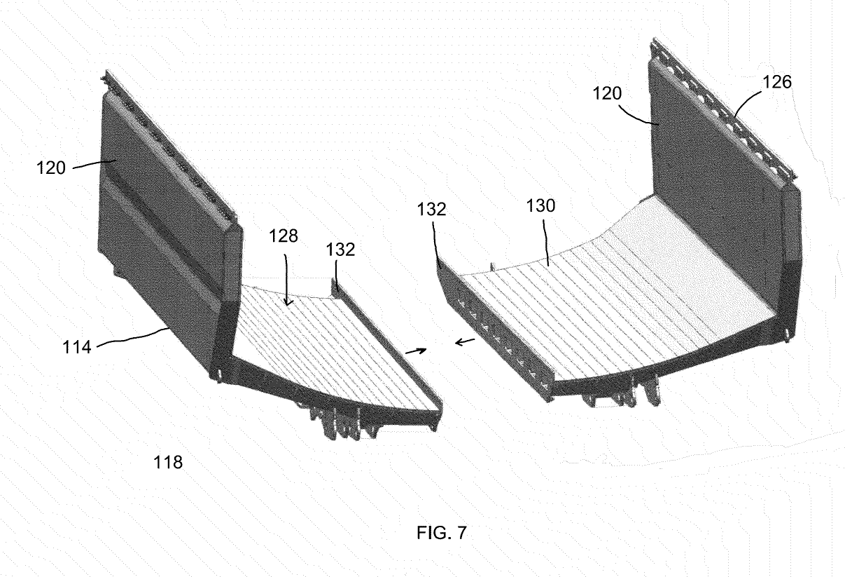

In one or more embodiments one or more elements of the receptacle 104 can be individual elements that are attached or otherwise fastened together with other elements to form the receptacle 104. In such embodiments, the floor 112 and receptacle 104 can be disassembled broken down into smaller individual elements, which may be advantageous for reducing costs and complexity of manufacturing and for reducing the costs and complexity of shipping. For example, referring additionally to FIGS. 7-9, In some embodiments, the floor 112 includes two or more pieces that are assembled together to form the floor 112. For example, depicted in FIG. 7, the floor 112 includes a first piece 128 and a second piece 130. In one or more embodiments, in assembly, the first piece 128 and second piece 130 of the floor are aligned and brought together at the lengthwise seam 132. Subsequently, the pieces can be attached together via fasteners, welded, or otherwise connected together to form the floor 112.

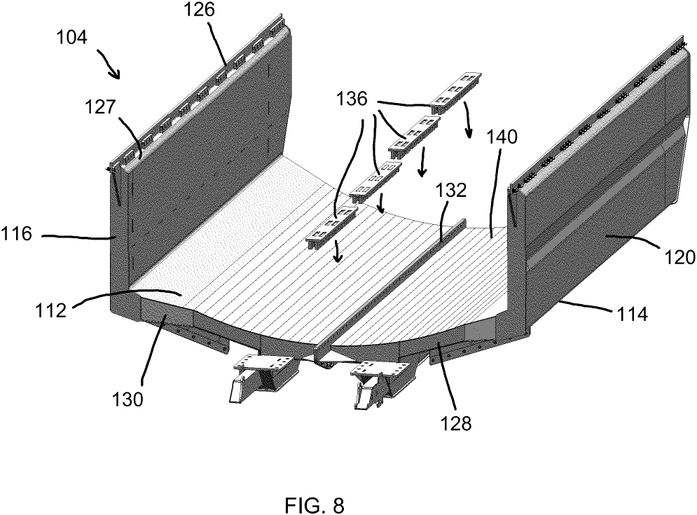

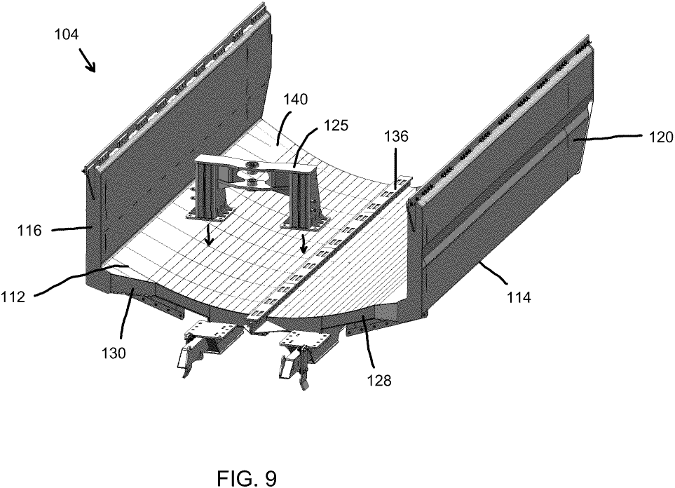

In various embodiments the floor 112 further includes a floor mounting rail 136 attached to a top surface 140 of the floor 112.Described further below, in various embodiments the floor mounting rail 136, in combination with the side mounting rails 126, provides at least a portion of an ejector blade mounting means on the receptacle 104, where the floor mounting rail 136 is received by an ejector blade mounting assembly to assist the ejector blade 108 to move between the forward end 116 and the rear end 118. Depicted in FIGS. 8-9, in one or more embodiments the floor mounting rail 136 can include one or more rail elements that together form an upwardly extending track on the top surface 140 and that extends along at least a portion of the floor 112 to at least the rear end 118. In various embodiments, the floor mounting rail 136 is attached to the floor 140 at the lengthwise seam 132. In such embodiments, the one or more rail elements can be attached to the lengthwise seam 132 via fasteners, bolts, welds, or other attachment methods.

Described further below, in various embodiments the floor mounting rail 136 is configured to have a shape that generally widens as the mounting rail 136 extends upwardly. For example, in various embodiments the mounting rail 136 possesses a lower portion 137 where the floor mounting rail 136 attaches to the floor 112 and a relatively wider upper portion 138. Depicted in the figures herein, the floor mounting rail 136 possesses a T-shape, with a flat wide top portion relative to the thinner lower portion attached to the lengthwise seam 132. However, in various embodiments the floor mounting rail 136 could possess any suitable shape, for example it could be tapered, rounded, or have any suitable shape that widens upwardly. Described further below, as a result of the shape of the floor mounting rail, in various embodiments the floor mounting rail when received by a corresponding mount in the ejector blade, supports the blade and also resists upward movement of the blade and assists to keep the blade from twisting or other non-standard movement. Depicted in FIG. 9, in various embodiments the hydraulic support structure 125 is attached to the forward end 116 of the receptacle 104. In various embodiments, once the hydraulic support structure 125 is attached, the hydraulic actuator 129 can be attached to the hydraulic support structure 125 and the ejector blade 108.

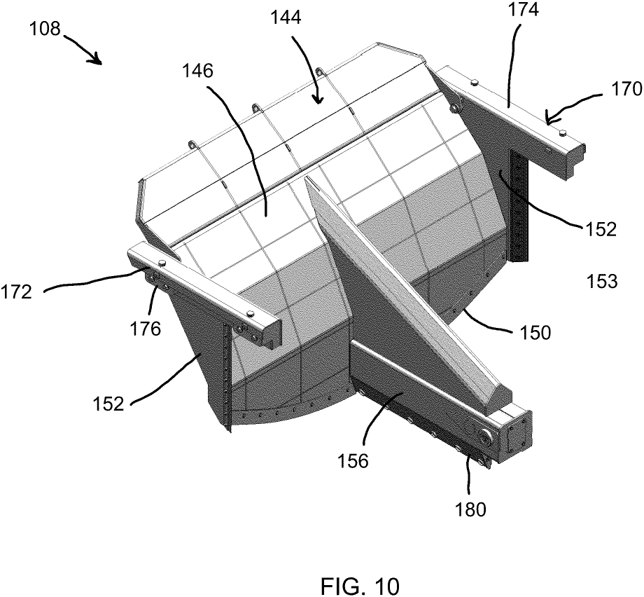

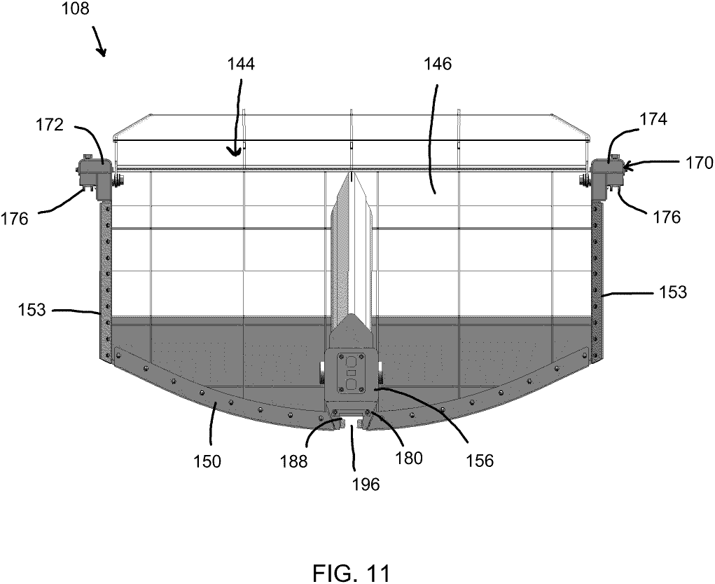

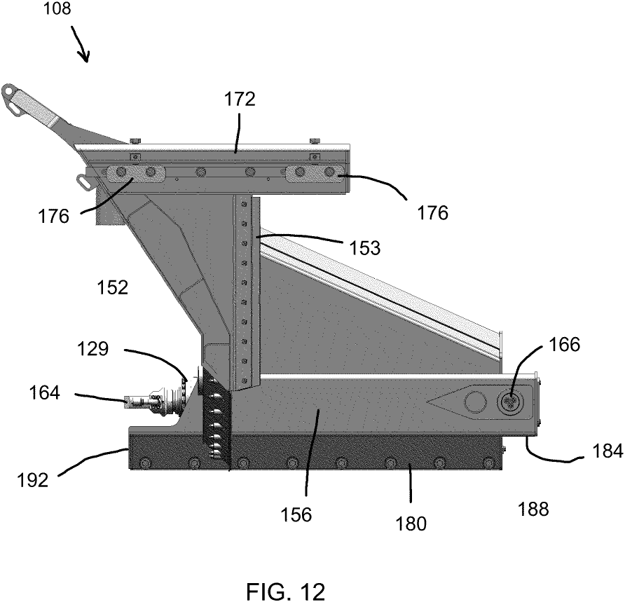

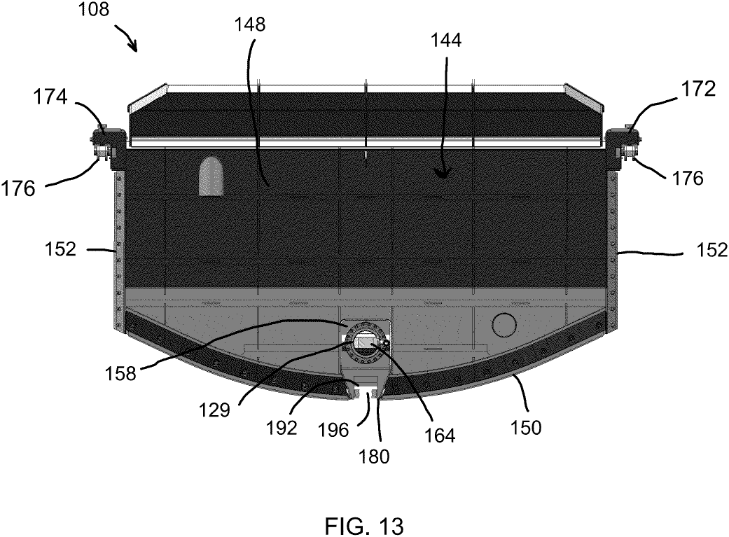

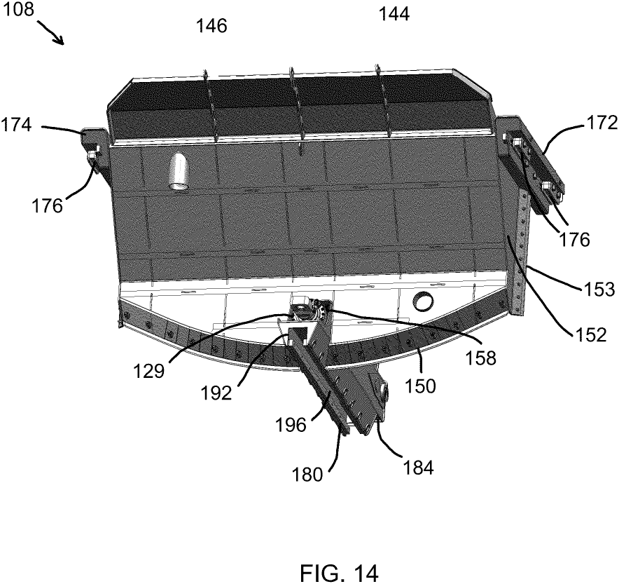

Referring additionally to FIGS. 10-14, in one or more embodiments the ejector blade 108 includes a body portion 144 having a rectangularly shaped, laterally, and vertically extending structure having a rearward facing surface 146 and a forward-facing surface 148. In various embodiments the ejector blade 108 has a laterally extending rigid lower portion 150 adjacent to the floor 112 and vertically extending rigid side portions 152 adjacent to the sidewalls 120. In one or more embodiments the vertically extending side portions 152 each further include a side scraper blade 153. In one or more embodiments the side scraper blades 152 are attachments to the ejector blade 108 configured to improve the ejector blades 108 ability to clean or remove material from the sides of the receptacle 104. In such embodiments, the sidewalls and scraper blades are closely conforming such that the blades are able to scrape against the side of the sidewalls to remove any material from the receptacle.

As such, an advantage of various embodiments is that the ejector blade 108 is able to remove all material out of the receptacle body to reduce material carry back and reduce the likelihood that the ejector blade 108 becomes jammed or twisted. In contrast, ejector devices of the prior art can include side mounts or other structural features in the sidewall of the receptacle for mounting the ejector blade. The inventors have determined that such features in the prior art can cause material to become stuck or frozen to the sides of the receptacle body or even lodged between the ejector blade and the sidewall and can result in jamming or twisting of the ejector blade as the material is being ejected. This is particularly an issue where the material is wet, such as clay, or in cold weather operations.

In one or more embodiments the ejector blade 108 further includes a hydraulic housing 156 extending rewardly from the body portion 144 and defining a space 158 in the forward-facing surface 148 for at least partially containing a hydraulic actuator 162. In various embodiments the hydraulic actuator 162 includes a first end 164 connected to the hydraulic support structure 129 and a second end 166 mounted to the interior of the hydraulic housing 156. In one or more embodiments the hydraulic actuator 162 is configurable between a retracted position and an extended position for moving the ejector blade 108 between the forward end and rearward end of the receptacle. For example, depicted in FIGS. 1-5, the ejector blade 108 is in a retracted position with the hydraulic actuator substantially located within the hydraulic housing 156. In contrast, depicted in FIG. 6, the ejector blade 108 is in an extended position with hydraulic actuator extended outwardly from the housing 156 and applying a translational force on the ejector blade 108 against the hydraulic support structure 125.

In various embodiments, the ejector blade 108 is slidingly mounted to the receptacle 104 via an ejector blade mounting assembly 170. In various embodiments, the mounting assembly 170 is composed of multiple support elements that are connected to the ejector blade 108 and are configured to interface with one or more corresponding mounts on the receptacle 104 to allow the ejector blade 108 to be both structurally supported on the receptacle 104 and to also move or slide on receptacle 104 for ejecting material. For instance, in various embodiments the mounting assembly 170 includes a first side mount 172 and second side mount each 174 connected to the side portions 152 of the body portion 144. In one or more embodiments the first and second side mounts 172, 174 each include one or more sleds 176 for receiving a respective side mounting rail 126 to support the ejector blade 108 on the opposing sidewalls 120. In various embodiments, the sleds 176 contain no moving parts and instead are configured to provide a relatively low friction surface that slides against the mounting rails 126. In such embodiments, and in contrast with prior art utilizing rollers or other movable parts to support the ejector blade 108, the sleds 176 reduce the likelihood of material becoming clogged in the mounting assembly 170.

In one or more embodiments, the mounting assembly 170 includes a central mount 180 that is configured for insertion onto the floor mounting rail 136 to interface with the receptacle 104 and to allow the ejector blade 108 to be structurally supported on the receptacle 104, via the floor mounting rail 136, and to also move or slide on the floor mounting rail 136 for ejecting material. In various embodiments, the central mount 180 is positioned on a bottom surface 184 of the hydraulic housing 156 wherein the central mount 180 includes a rearward aperture 188 and a forward aperture 192 and defines a pathway 196 between to receive the floor mounting rail 136.

As described above, the floor mounting rail 136 has a T-shape, with a flat wide top portion relative to the thinner lower portion attached to the lengthwise seam 132. In various embodiments the rearward aperture 188 and forward aperture 192 correspond with the shape of the floor mounting rail 136 such that it can be received into the pathway 196 to connect the mounting assembly 170 to the receptacle 104. As a result of the shape of the floor mounting rail 136, in various embodiments the floor mounting rail when received by a corresponding mount in the ejector blade, supports the blade and resists upward movement of the blade and assists to keep the blade from twisting or other non-intended movement.

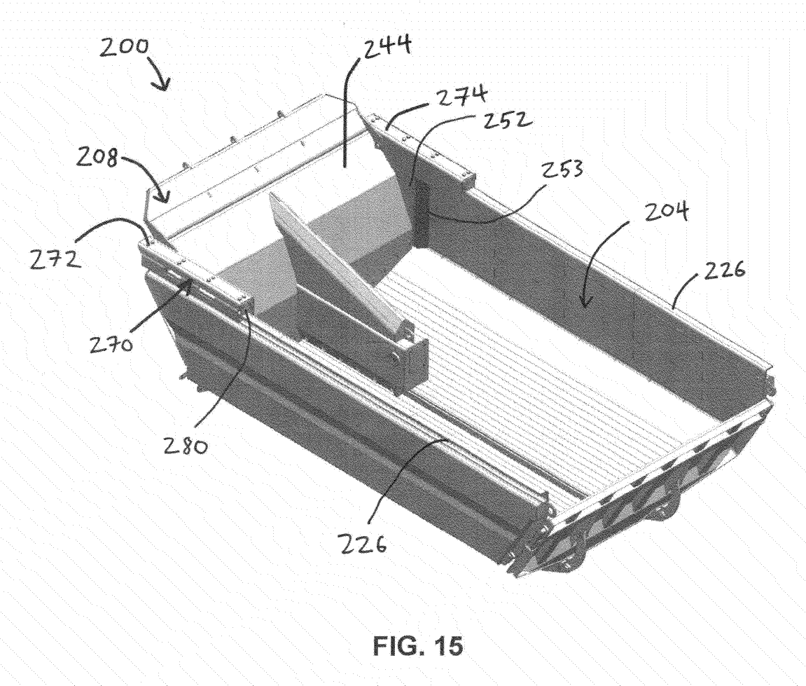

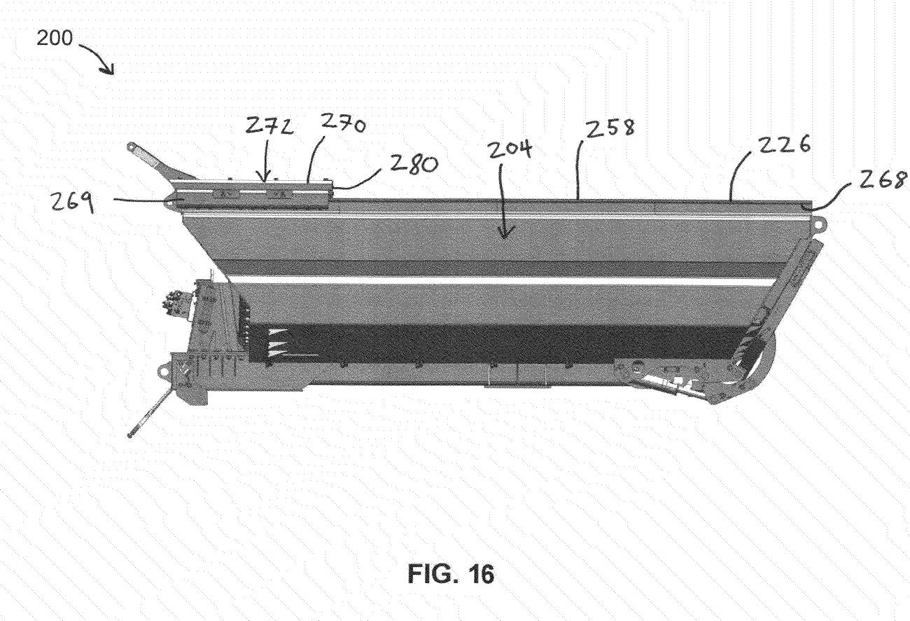

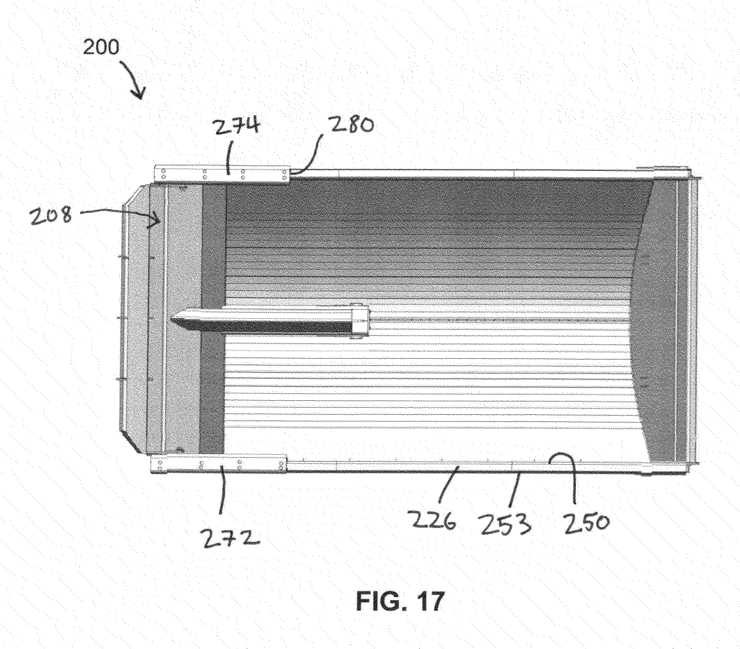

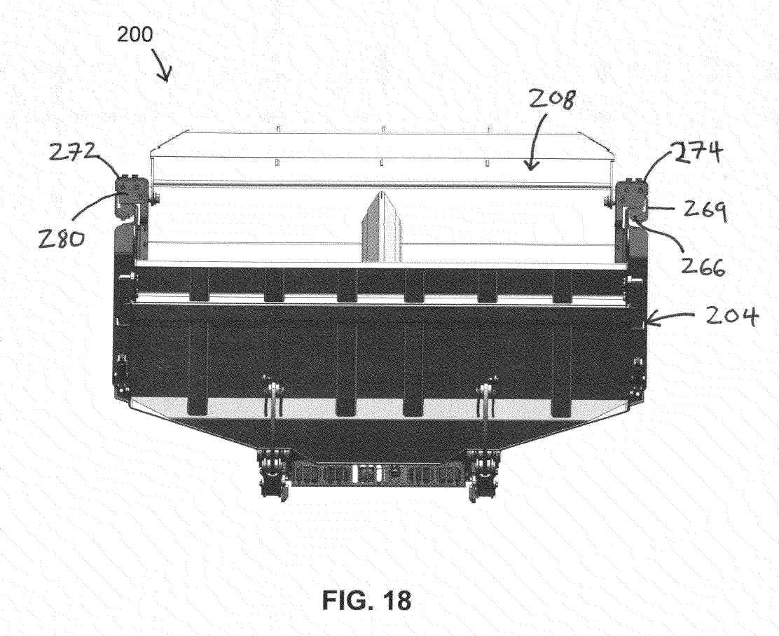

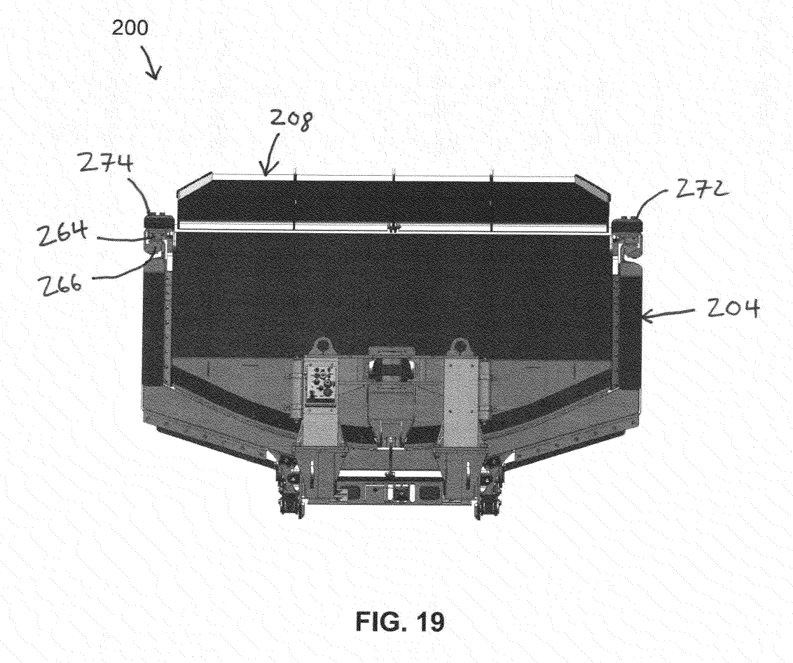

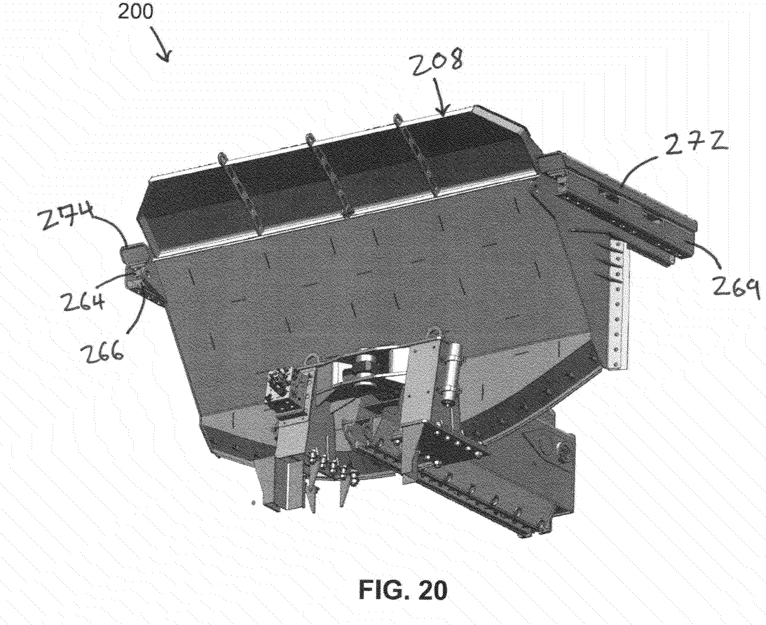

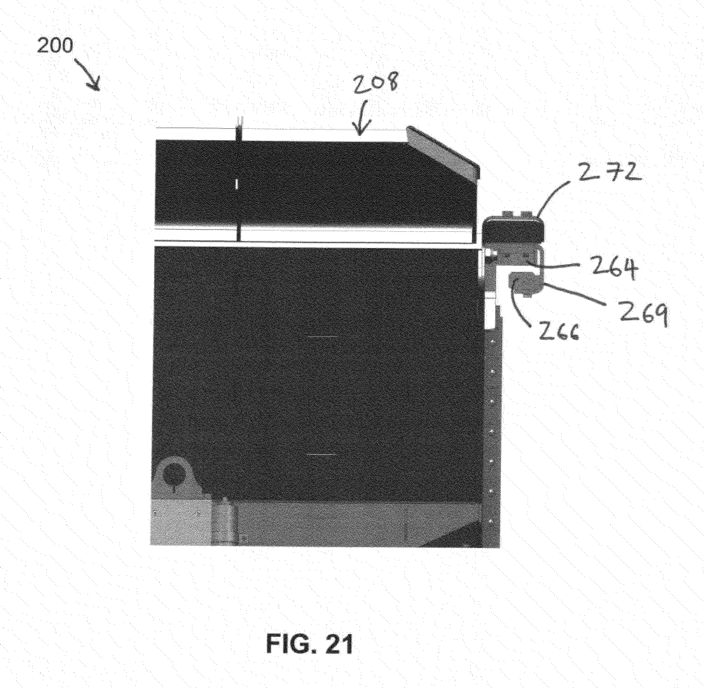

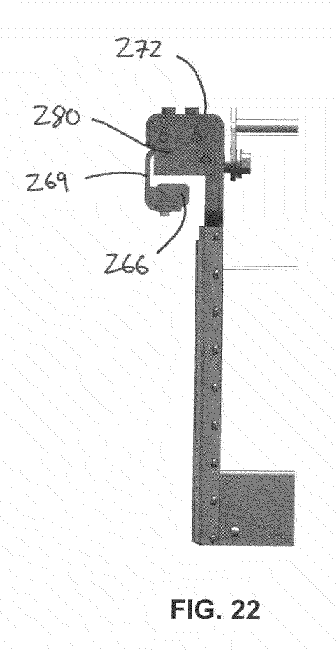

Referring to FIGS. 15-22, various views of an ejector box 200 is depicted according to one or more embodiments of the disclosure. According to various embodiments, the ejector box 200 is similar to ejector box 100, including a receptacle 204 that is configured to contain material, and an ejector blade 208 for dumping or ejecting the material out of the receptacle 204. Further, in various embodiments, the ejector box 200 is attachable to a working vehicle such as a truck, tractor, articulated truck, or other vehicle. As such, in various embodiments the receptacle 204 and ejector blade 208 can contain the same elements as their respective counterparts in ejector box 100. In one or more embodiments, the ejector box 200 includes a pair of side mounting rails 226 that are attached to a top end 227 of each of the sidewalls 220 to form an upwardly extending track or rail on the sidewalls 220. In such embodiments each of the opposing sidewalls 220 have a top end 227 having an inward edge 250 that faces inwardly towards the interior of the receptacle 204 and an outward edge 253 which faces away from the interior of the receptacle 204. In various embodiments the side mounting rails 226 provide at least a portion of an ejector blade mounting means on the receptacle 204, where the side mounting rails 226 are received by an ejector blade mounting assembly to allow the ejector blade 208 to move between the forward end and the rear end.

In one or more embodiments each of the side mounting rails 226 include a vertically extending portion 254 that is connected to the inward edge 250 of the opposing sidewalls 220 and a laterally extending portion 256 extending from the vertically extending portion 254 towards the outward edge 253 and over the top end 227 of the opposing sidewalls 220. In such embodiments, the side mounting rails 226 define generally flat top surface 258, a bottom surface, and a region 260 for receiving a portion of the first and second side mounts 272, 274 of the ejector blade 208. In such embodiments the side mounting rails 226 define a generally C-shape structure, with the open region 260 being exposed to the outside of the receptacle. In such embodiments, the C-shape allows for the side mounting rails 226 allows for placement of corresponding upper and lower slides that allow the side mounts to function to allow for movement of the ejector blade while also resisting upward movement of the ejector blade against the laterally extending portion 256 of the side mounting rails 226. Further, in various embodiments the C-shape rails allow for material to be more easily scraped off or otherwise removed, reducing the chances of material jamming or slowing the movement of the ejector blade 208.

The ejector blade 208 is slidingly mounted to the receptacle 204 via an ejector blade mounting assembly 270. In various embodiments, the mounting assembly 270 is composed of multiple support elements that are connected to the ejector blade 208 and are configured to interface with one or more corresponding mounts on the receptacle 204 to allow the ejector blade 208 to be both structurally supported on the receptacle 204 and to also move or slide on receptacle 204 for ejecting material. For instance, in various embodiments the mounting assembly 270 includes a first side mount 272 and second side mount each 274 connected to the side portions 252 of the body portion 244. In one or more embodiments the first and second side mounts 272, 274 each include a top sled 264 for receiving the respective top surface 258 of the side mounting rail 226. In various embodiments the side mounts 272, 274, and a bottom sled 266 for receiving a respective bottom surface 268 of the side mounting rail 226. In such embodiments the bottom sled 266 operates to resist upward movement of the ejector blade while the top sled operates to support the ejector blade 208 on the side mounting rail 226 and allow for the ejector blade to move or slide on receptacle 204 for ejecting material. In one or more embodiments, the bottom sled is supported on a sled mounting structure 269 that is connected to the first and second side mount 272, 274. In various embodiments the sled mounting structure 269 includes a first end connected to the side mount 272, 274 and a second end 271 that is extended downwardly and laterally under the side mount 272, 274 to define a surface for mounting the bottom sled 266.

In such embodiments the sled mounting structure and the side mounts form a generally C-shaped structure. In such embodiments, the C-shape of the sled mounting structure 269 corresponds with the C-shaped structure of the side mounting rails 226 such that the side mounts 272, 274 and the sled mounting structure 269 can fit with the side rails to allow the ejector body 208 to slide along the rails. In various embodiments, the sleds 276 contain no moving parts and instead are configured to provide a relatively low friction surface that slides against the mounting rails 226. In such embodiments, and in contrast with prior art utilizing rollers or other movable parts to support the ejector blade 208, the sleds 276 reduce the likelihood of material becoming clogged in the mounting assembly 270. In one or more embodiments, the side mounts 272, 274 further include a forward scraper 280 configured to scrape or otherwise remove material from the top surface of the rail 226.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A rear ejector body for use with a work vehicle, the ejector body comprising:
a receptacle including a floor and a pair of opposing sidewalls that extend upwardly from the floor, the floor and sidewalls defining a forward end of the receptacle and an open rearward end of the receptacle;
side mounting rails attached to a top end of each of the pair of opposing sidewalls, the side mounting rails extending to the open rearward end along at least a portion of a length of the receptacle;
a floor mounting rail attached to a top surface of the floor, the floor mounting rail extending to the open rearward end along at least a portion of a length of the receptacle;
an ejector blade having a body extending between the pair of opposing sidewalls and including a lower portion adjacent to the floor and side portions adjacent to the opposing sidewalls, the ejector blade further including a hydraulic housing extending rewardly from the ejector blade body for at least partially containing a hydraulic actuator, wherein the ejector blade is slidingly mounted to the receptacle via an ejector blade mounting assembly comprising:
a first side mount and second side mount each connected to the side portions of the ejector blade body, the first and second side mount each including a sled for receiving a respective side mounting rail to support the ejector blade on the opposing sidewalls; and
a central mount configured for insertion onto the floor mounting rail, the central mount positioned on a bottom surface of the hydraulic housing wherein the central mount includes a rearward aperture and a forward aperture and defines a pathway between to receive the floor mounting rail, the floor mounting rail having a wider top portion than bottom portion such that the floor mounting rail, when received in the pathway of the central mount, resists upward movement of the ejector blade; and
wherein the hydraulic actuator includes a first end connected to a first hydraulic support structure attached to the forward end of the receptacle and a second end mounted to the hydraulic housing, wherein the hydraulic actuator is configurable between a retracted position and an extended position for moving the ejector blade between the forward end and rearward end of the receptacle.

2. The ejector body of claim 1, further comprising a tailgate pivotally attached to the rear end of the receptacle and positioned between the pair of opposing sidewalls, the tailgate configured for movement between a closed position, where the tailgate forms a barrier at the rearward end of the receptacle for containing material in the receptacle, and an open position, where the tailgate allows material contained in the receptacle to be ejected from the rear end of the receptacle.

3. The ejector body of claim 1, wherein the floor mounting rail is T-shaped.

4. The ejector body of claim 1, wherein the side portions of the ejector blade each further include a side scraper blade closely conforming with the sidewalls such that in operation the side scraper blades scrape against the side of the sidewalls for removing material from the receptacle.

5. The ejector body of claim 1, wherein the receptacle is modular, and the floor comprises a first piece and a second piece that are assembled together along a lengthwise seam that extends between the forward end and the open rearward end of the receptacle to form the floor.

6. The ejector body of claim 5, wherein the floor mounting rail is attached to the top surface of the floor at the lengthwise seam.

7. The ejector body of claim 5, wherein the floor mounting rail is centrally located between the opposing sidewalls.

8. The ejector body of claim 1, wherein the ejector blade mounting assembly contains no individually moving parts.

9. The ejector body of claim 1, wherein each of the opposing sidewalls have a top surface having an inward edge and an outward edge;
wherein the side mounting rails each have a vertically extending portion connected to the inward edge of the opposing sidewalls and wherein the side mounting rails each have a laterally extending portion extending from the vertically extending portion towards the outward edge and over the top surface of the opposing sidewalls;
wherein the vertically extending portion and laterally extending portion define a top surface of the side mounting rail, a bottom surface of the side mounting rail, and a region for receiving a portion of the first and second side mounts of the ejector blade for resisting upward movement of the ejector blade;.

10. The ejector body of claim 9, wherein the sled of first and second side mount is a top sled for receiving a respective top surface of the side mounting rail to support the ejector blade on the opposing sidewalls.

11. The ejector body of claim 10, wherein the first and second side mount further include a bottom sled for receiving a respective bottom surface of the side mounting rail to resist upward movement of the ejector blade.

12. The ejector body of claim 11, wherein the first and second side mount further include a sled mounting structure having a first end connected to the side mount and a second end extended under the top sled and defining a bottom surface for mounting the bottom sled.

13. The ejector body of claim 9, wherein the first and second slide mount further include a scraper positioned at a forward end of the side mount, the scraper configured to remove material from the top surface of the side mounting rail.

14. An ejector truck comprising:
a work vehicle; and
a rear ejector body attached to the work vehicle, the ejector body comprising:
a receptacle including a floor and a pair of opposing sidewalls that extend upwardly from the floor, the floor and sidewalls defining a forward end of the receptacle and an open rearward end of the receptacle;
side mounting rails attached to a top end of each of the pair of opposing sidewalls, the side mounting rails extending to the open rearward end along at least a portion of a length of the receptacle;
a floor mounting rail attached to a top surface of the floor, the floor mounting rail extending to the open rearward end along at least a portion of a length of the receptacle;
an ejector blade having a body extending between the pair of opposing sidewalls and including a lower portion adjacent to the floor and side portions adjacent to the opposing sidewalls, the ejector blade further including a hydraulic housing extending rewardly from the ejector blade body for at least partially containing a hydraulic actuator, wherein the ejector blade is slidingly mounted to the receptacle via an ejector blade mounting assembly comprising:
a first side mount and second side mount each connected to the side portions of the ejector blade body, the first and second side mount each including a sled for receiving a respective side mounting rail to support the ejector blade on the opposing sidewalls; and
a central mount configured for insertion onto the floor mounting rail, the central mount positioned on a bottom surface of the hydraulic housing wherein the central mount includes a rearward aperture and a forward aperture and defines a pathway between to receive the floor mounting rail, the floor mounting rail having a wider top portion than bottom portion such that the floor mounting rail, when received in the pathway of the central mount, resists upward movement of the ejector blade; and
wherein the hydraulic actuator includes a first end connected to a first hydraulic support structure attached to the forward end of the receptacle and a second end mounted to the hydraulic housing, wherein the hydraulic actuator is configurable between a retracted position and an extended position for moving the ejector blade between the forward end and rearward end of the receptacle.

15. The ejector truck of claim 14, further comprising a tailgate pivotally attached to the rear end of the receptacle and positioned between the pair of opposing sidewalls, the tailgate configured for movement between a closed position, where the tailgate forms a barrier at the rearward end of the receptacle for containing material in the receptacle, and an open position, where the tailgate allows material contained in the receptacle to be ejected from the rear end of the receptacle.

16. The ejector truck of claim 14, wherein the floor mounting rail is T-shaped.

17. The ejector truck of claim 14, wherein the side portions of the ejector blade each further include a side scraper blade closely conforming with the sidewalls such that in operation the side scraper blades scrape against the side of the sidewalls for removing material from the receptacle.

18. The ejector truck of claim 14, wherein the receptacle is modular, and the floor comprises a first piece and a second piece that are assembled together along a lengthwise seam that extends between the forward end and the open rearward end of the receptacle to form the floor.

19. The ejector truck of claim 14, wherein the floor mounting rail is attached to the top surface of the floor at the lengthwise seam.

20. The ejector truck of claim 14, wherein the floor mounting rail is centrally located between the opposing sidewalls.
